(19) United States
(12) Patent Application Publication
(10) Pub. No.: US 2016/0108658 A1
(43) Pub. Date: Apr. 21, 2016

(54) INVISIBLE WINDOW FRAMES

(71) Applicants: LV Tendens B.V. GCV; RINVISIBLE BVBA, Beringen (BE)

(72) Inventor: Ringo Cruysberghs, Beringen (BE)

(73) Assignee: LV Tendens B.V. GCV, Grobbendonk (BE)

(21) Appl. No.: 14/893,138

(22) PCT Filed: May 22, 2014
(86) PCT No.: PCT/EP2014/060542

§ 371 Date: Nov. 23, 2015

(30) Foreign Application Priority Data
May 23, 2013 (EP) 13002678.4

(51) Int. Cl. E06B 3/06; E06B 3/54; E06B 3/263

(52) U.S. Cl. CPC E06B 3/06; E06B 3/263; E06B 3/5454

(57) ABSTRACT

The present invention concerns the placement of windows in such a way that the window frames are not visible from the outside and/or the inside of the wall. The invention further concerns the window frames in which the window glass can be placed and further the combination of a window frame together with a demountable interior finishing. By placing the windows according to this invention there are no visible window profiles and a visual effect can be created that the inside space is part of the outside space.

### FIELD OF THE INVENTION

The invention below concerns the installation of windows in such a way that the window frames are not visible from the outside and/or the inside of the wall. The invention further concerns window frames in which window panes can be mounted as well as the combination of a window profile and a demountable interior finishing. The invention may further include a ventilation channel as well as frame parts made by extrusion. The invention further concerns the window profiles and frames made thereof, allowing such invisible installation.

### BACKGROUND OF THE INVENTION

The current state of the art with respect to installation of windows assumes window profiles which are clearly visible and are part of the appearance of the building. Indeed, the shape, the width, the colour and the pattern of the window profile define in part the general architectural impression of the building.

There is also a technical reason for the presence of the profiles, namely the placing of windows which can swivel open through means of hinges. To use such opening windows it is necessary for the profile, or at least a jamb of the profile, not to stay behind the outer wall or the outer covering or if necessary the inner wall or inner covering. The classic functioning of hinges requires that the profile or at least a jamb of the profile protrudes somewhat to allow the window to swivel open, be it inward or outward.

However there are also disadvantages to such use of visible window profiles such as: inconvenience for maintenance, cost, necessity to provide the window profiles of a certain colour, the difficulty of installing the classic window profiles, the—in some cases—fairly complex structure of the window profiles (whereby these are of course more expensive), the trouble that must be gone through to protect windows with the current window profiles from burglary. The complex structure of the windows is necessary to make the window frame sufficiently insulating by interrupting a thermal bridge optionally with different cavities.

### SUMMARY OF THE INVENTION

The invention below can provide a solution to several disadvantages offered by the frames or window profiles of the state of the art. Below the term “frame” or “window frame” will be used to refer to the frame according to the invention while “window profile” rather will be used for the embodiments of the state of the art, as well as to the jambs, hereinafter also referred to as the frame parts making up the window frame.

Such art known profiles have a limited thickness as they are posted in the wall cavity against an edge generated by the outer building elements. For some of the reasons given herein before, the width of such art known profiles is typically larger than the height of the edge generated by the outer building elements, they accordingly protrude beyond said edge and are visible from the outside. It is an object of the present invention to provide window profiles that can be installed invisible from the outside.

With reference to the enclosed figures. The window profiles of the present invention for this purpose consist of bar (beam)-shaped profiles (1) extending over the entire width of the inner wall and having a thickness lower than the edge formed by the outer building elements (20). The broad beam-shaped profiles are placed with their thin side facing the upright edge of the outer building elements and on this side, in turn, provided with a raised edge (6) or chamber (8) having a height which is approximately equal to the height of the edge formed by the outer building elements (20). Against this edge the glass pane (30a, 30b) will be placed. In order to hold the glass in place, a glazing bead (4), clamps or other means to keep the glass at the appropriate position, will be fixed on the beam-shaped profiles against the glass. Subsequently, and in order to realize an invisible installation from the inside, a demountable interior finish (40) that is placed over the glazing beads and the full width of the inside wall.

In one embodiment of the invention, the beam-shaped profiles are hollow. In particular, provided with distribution elements (1e, 7b) which may divide the hollow profiles into two or more rooms. One or more of these distribution elements are preferably situated on the side of the upstanding edge over a width at least equal to the thickness of the loaded glass. In the embodiment in which the beam-shaped sections are provided with an upright chamber (8), there may be a removable cover (7d). This cover provides access to the underlying cavity, and to the extent that the dividers are knocked out, this will allow the user to provide the window profiles with attributes such as embedded modules for roller shutters, sun protection, ventilation, etc. . . . . The window profiles therefore allow that the functionality of the window profiles can still be personalized or changed after installation by adding or changing the attributes within the window profiles.

The typical characteristics of the profiles are thus that their width extends across the full width of the inside wall. That their thickness is lower than the outer edge of the construction and in that an interior finish is placed over the profile. This interior finish will typically bridge the gap between the top of the edge generated by the outer building elements and the thickness of the profile. Thus when in position, the interior finish visually runs to the edge formed by the outer building elements and the window frame is completely hidden from view. Due to the placement of the profiles over the entire width of the inner building shell, and a corresponding underlying insulation (23), the window profiles of the present invention can provide a perfectly airtight window placement, such as desired in passive and low-energy buildings.

Thus in one embodiment the present invention provides a window frame comprising beam shaped profiles (1), characterized in that the width (b) of said beam shaped profiles cover the entire width of the inner wall (22); characterized in that the height (h) of said beam shaped profiles is less than the height of the edge generated by the outer building elements (20); characterized in that the window frame further comprises an demountable interior finishing (40); and further characterized in that the beam shaped profiles comprise a raised edge (6) or chamber (8) at the side facing the exterior.

Per reference to FIG. 1 and as further described herein below, the width (b) is determined by the measurements of the building shell elements in which the frame needs to be placed and extends over the full width of the inner wall. In the embodiment shown in FIG. 1, it even bridges the breath of the wall cavity (21). Thus in an embodiment of the present invention, the beam shaped profiles cover the entire width of the inner shell of the building shell elements. In either instance, the beam shaped profiles of the present invention lay with the side (1d) comprising the raised edge (6) or chamber (8) against the outer building shell elements (21). Also the height of said raised edge or chamber ((h) plus (s)) is determined by the measurements of the building shell elements in which the frame needs to be placed and equals up to the height of the edge generated by the outer building elements. As explained hereinafter, in one embodiment the raised edge (6) of the profiles comprises a lip or collar (6b) that rests after placement upon the outer building elements. Further to supporting the window frame jamb, for example when present as the sill, i.e. at the base of the window frame, this collar also allows a watertight placement of the window frame in preventing water from entering the wall cavity and enabling water drainage to the outer shell of the building shell elements.

As evident from the exemplified embodiments, in a preferred embodiment of the present invention, the beams shaped profiles are hollow. Thus in said embodiment the present invention provides a window frame comprising hollow beam shaped profiles (1), characterized in that the width (b) of said beam shaped profiles cover the entire width of the inner wall (22); characterized in that the height (h) of said beam shaped profiles is less than the height of the edge generated by the outer building elements (20); characterized in that the window frame further comprises an demountable interior finishing (40); and further characterized in that the beam shaped profiles comprise a raised edge (6) or chamber (8) at the side facing the exterior. Extending of over the full width (b) of the inner shell of the building shell elements and accordingly over the full surface of the edges of the window opening in the building shell elements, the hollow beam shaped profiles of the present invention create a space that allows hidden installation of attributes such as embedded modules for roller shutters, sun protection, ventilation, water drainage, etc. . . . . The more, this hidden installation is still possible post-installation of the window frames according to the present invention. In a particular embodiment, and per reference to FIG. 5, the head or upper beam of the window frame comprises a ventilation channel. As further explained hereinafter, its presence allows efficient ventilation of the building without the need of opening windows. Preferably the ventilation channel comprises closure means allowing the user to control the opening of the ventilation channel. Thus in one embodiment the present invention provides a window frame wherein a ventilation channel is incorporated in one or more of the beam shaped profiles; in particular in the head (upper) profile of the window frame.

At the side facing the outer building elements, the beam shaped profiles either comprise a raised edge (6) or chamber (8). As evident from the exemplified embodiments, in a preferred embodiment said chamber (8) is an integrated part of the beam shaped profiles, and divided therefrom by means of dividing member (7b). Thus in one embodiment of the present invention, the raised chamber (8) is an integrated of the beam shaped profiles comprising said chamber; in particular an integrated part of the hollow beam shaped profiles comprising said chamber. Dividing member (7b) may separate this chamber from the hollow beam shaped profile (1). As such presenting one of the embodiments wherein the beam shaped window profiles comprise two or more chambers ((8), (2a), (2b)). It is thus an embodiment of the present invention to provide window frames characterized in that the hollow beam shaped profiles comprise one or more dividing members (1e, 1f, 7b), separating the hollow beam shaped profiles in two or more chambers (2a, 2b, 8). As will be evident to the skilled artisan, the dividing members may provide structural strength to the window profiles and are accordingly positioned within the frame parts where said additional strength is actually required. For example per reference to FIG. 4, a first dividing member is found next to the position of the fastening means (2) fixing the frame part to the inner shell (23) of the building. In FIGS. 1 and 4, dividing members are present underneath or just next to the position where the glass pane is supported by the window profile. In FIG. 4, even including a cross-shaped dividing member giving extra structural strength to the profile at said position. Thus in one embodiment the present invention provides window frames characterized in that dividing members are present at the side of the hollow beam shaped profiles comprising the raised edge (6) or chamber (8), over a distance of at least the thickness of the window pane that will be mounted in the frame. The hollow chambers within the beam shaped profiles also contribute to the insulation characteristics of the window frames according to the present invention. In order to enhance the insulation, upon installation the window frames of the present invention are preferably placed against an insulation layer (see (23) in FIG. 1) covering the edges of the window opening in the building shell elements. If desired, and in said embodiment wherein the hollow beam shaped profiles comprise two or more chambers, insulation characteristics of the profiles may further modified by filling one or more of said chambers with an insulation material. It is thus an object of the present invention to provide window frames wherein one or more of chambers within the hollow beam shaped profiles are filled with an insulating material.

In one embodiment, one or more of the dividing members are removable. This allows adaptation of the profiles to the needs of the user, and post-installation insertion of attributes (supra). Said insertion of attributes typically occurs at the sill or head of the window frame. Hence, in one embodiment of the present invention the window frame comprises hollow beam shaped profiles (1) as described herein, characterized in that the hollow beam shaped profiles making up the jambs (sides) of the window frame comprise a raised edge (6) at the side facing the exterior and wherein a hollow beam shaped profiles making up the sill (base) or head (upper) of the window frame comprises a raised chamber (8) at the side facing the exterior. In an even further embodiment the window frame comprises hollow beam shaped profiles (1) as described herein, characterized in that the hollow beam shaped profiles making up the jambs (sides) of the window frame comprise a raised edge (6) and in that the hollow beam shaped profiles making up the sill (base) and head (upper) of the window frame comprises a raised chamber (8) at the side facing the exterior. To enable the insertion of the attributes, the chamber (8) may comprise a removable lid (7d). For example, at the sill of the window frame, the chamber (8) may function as a water drainage channel or allow insertion of water drainage means. Bridging to the outside of the window pane, being in direct contact with the window pane and being at level with the outer building elements it enables water drainage to the outside of the building shell and prevents infiltration of water in between the inner and outer building shell elements.

The raised edge (6) or chamber (8) provide a face to which the window pane (30a, 30b) is inserted into the window frame. Evidently, and as will be evident for the skilled artisan from the exemplified embodiments, when comprising beam shaped profiles of the present invention with raised edges and chambers, sides 6a and 7a will be juxtaposed to one another. To maintain the glass pane in position, any suitable glass retainment elements (4) can be used, and will be fixed to the beam shaped profiles as described herein. Thus in one embodiment the window frame according to any one of the provided embodiments, further comprising glass retainment elements (4), in particular demountable glass retainment elements. Per reference to the figures below, an interior covering or finishing (40) is mounted over said glass retainment elements (4). In particular said interior finishing is demountable, allowing replacement of the glass pane without damaging the interior wall finishing. In order to enable that the interior covering (40) visually extends or devolves into the outer building elements, the height of said glass retainment elements (4) preferably does not extends above the height (s) between the upper surface of the beam shaped profiles and the height of the edge generated by the outer building elements. In said instance the window frame of the present invention is further characterized in that the demountable interior finishing bridges the height (s) between the upper surface of the beam shaped profiles and the height of the edge generated by the outer building elements.

Further numbered embodiments of the present invention include;

1. Method for the placement of window frames and windows comprising the following steps:

a) the placement of a window frame in such a manner that the carrying frame is hidden behind the edges of the outer wall when looking from the outside in;
b) the placement of the window glass in the frame.

2. The method according to claim 1, wherein the window frame is placed after an insulating layer was applied to the building shell.

3. The method according to claim 1 or 2, whereby after the placement of the window glass, a demountable interior covering is placed such that the frame also becomes invisible from the inside looking out.

4. A frame suitable for comprising the glass according to the method of placement of windows according to claim 1, 2, or 3.

5. The frame according to claim 4, wherein the material of the frame is sufficiently rigid and strong to withstand the forces that are exerted on the frame and the window, such as the gravitational force or forces as a consequence of differences in air pressure.

6. The frame according to claim 5, wherein the material is chosen from a group consisting of wood, composite material or polymer, preferably polyvinylchloride.

7. The frame according to any of the claim 4, 5, or 6, wherein the cross section of the frame has a width of between about 20 cm and about 90 cm, more in particular a width between about 50 cm and about 70 cm.

8. The frame according to any of the claim 4, 5, 6, or 7 wherein the cross section of the frame has a height of between about 4 cm and about 12 cm, more in particular a height between about 6 cm and about 9 cm.

9. A frame according to any of the claim 4, 5, 6, 7, or 8 wherein a ventilation channel is incorporated.

10. A frame part (1) for a frame according to any of the claim 4, 5, 6, 7, or 8 comprising 4 frame sides (1a, 1b, 1c, 1d) and frame part (6) as one whole, wherein the cavity (2) is optionally filled with an insulating material.

11. A frame part (1) for a frame according to any of the claim 4, 5, 6, 7, or 8 comprising 4 frame sides (1a, 1b, 1c, 1d) and an extra frame part comprising frame sides (7a, 7b, 7c) wherein a cavity (8) is formed and that is suitable to comprise a window extending till the floor.

12. A frame part according to claim 10 or 11 wherein the frame part is made by extrusion of polyvinylchloride.

13. The inner covering (40) suitable for the finishing as provided for in the method according to claim 3.

14. The combination of a frame according to any of the claim 4, 5, 7 or 8 together with the window glass.

15. The combination according to claim 14, further combined with an inner covering according to claim 13.

### SHORT DESCRIPTION OF THE FIGURES

FIG. 1 shows a cross section of a simple embodiment of the frame according to the invention.

FIG. 2 shows a cross section of a frame part that acts as a base for a window in the wall.

FIG. 3 shows a cross section of a frame part that acts as a base for a window that extends till the floor.

FIG. 4 shows a cross section of a frame part for a window that extends till the floor, shown in an arrangement with glass and building shell elements.

FIGS. 5 and 6 shows an embodiment wherein a cross section is shown of a vertical cross section of the frame in which there is also a ventilation channel present.

FIG. 7 shows an embodiment wherein a cross section is shown of a vertical cross section of a frame part making up the sides or jambs of the window frame.

### DETAILED DESCRIPTION OF THE INVENTION

The current invention encompasses a method of the installation of window frames and windows. The method starts for example with the mounting of the window frame above the wall cavity and potentially the inside wall in such a way that the frame, and more specifically the bearing frame, remains hidden behind the edges of the outer wall (seen from the outside). Subsequently the method encompasses the installation of the window pane in the bearing frame. The window pane is usually not placed directly inside the frame but rests for example on a glass block.

Although the various examples (for example mentioned in the figures) are masonry walls, the invention is not limited to installment of windows in such walls. The invention can just as well be applied to wooden dwellings or so-called prefab dwellings or buildings made of other materials.

The invention below thus allows not using ‘conventional’ window profiles and can therefore avoid the disadvantages of the use of these ‘conventional’ window profiles.

During the construction only minimal account must be taken of the installment of the frame and windows in the method of the invention below. In a certain embodiment, the opening of the outer wall is smaller than the corresponding opening in the inner wall so that the frame can be “hidden” behind the outer wall or outer covering as explained in the figures. In the embodiment in which a ventilation channel is present it may be necessary to position a stone perpendicular to the rest of the wall for a part of the wall in case a masonry wall is provided for.

The invention can also be applied with refurbishment activities. There, the operation on the building shell can be more substantial compared to a building shell without windows according to the invention. For the sake of clarity, the outer structure of the wall does not need to be adapted. In a certain embodiment the opening in the inner wall needs to be enlarged to provide for the possibility to hide (as seen from the outside) the window frame behind the outer wall.

When an opening in the shell is provided, one may place the frame according to the invention in direct contact with the building shell elements (such as, but not limited to the outer wall, cavity, inner wall) or one may first apply an insulation layer. In some cases this insulation layer can also act as an equalization layer, in other words a layer which is capable of equalizing any unevenness of the building shell elements so as to form a plane or quasi-plane surface. That insulation layer can be an insulation sheet or a sprayed insulation layer. The person skilled in the art will be able to choose the right type of insulation. The thickness of the insulation layer depends on many factors. But the average thickness of the insulation layer will usually vary between a minimum of about 5 mm and a maximum of about 60 mm. All values in between such as about 10 mm, about 15 mm, about 20 mm, about 25 mm, about 30 mm, about 35 mm, about 40 mm, about 45 mm, about 50 mm, and about 55 mm are possible as well. Preferably the thickness of the insulation layer is about 10 mm to 20 mm. The type of insulation material and the unevenness that needs to be compensated for are amongst others factors that will determine the thickness of the insulation layer. The person skilled in the art is capable of making these choices.

The frame may be installed without fastening means in the opening. But the frame may also be installed by means of a number of fastening means. This may be done by means of screws or bolts or other means for fastening and/or support, such as, for example, when the frame spans a part or the entire width of the interior wall. In that case, for example, a screw may be fixed in a perpendicular or approximately perpendicular way through the frame (possibly through the insulating layer) into or against the inner wall. In order to make the installation even sturdier a plug can be fixed into the inner wall in such a way that the screw can be screwed into the plug rather than into the material of the inner wall. On the other hand mechanical angle connectors may also be used to fix the frame. The person skilled in the art can determine in which case and which mechanical angle connectors he is going to use. Mechanical angle connectors may be preferred in those places where the mechanical angle connector has no vertical support of the shell element. For example, when a part of the mechanical angle connector should be fastened above the wall cavity, there is no material to absorb the forces caused by gravity in the vertical direction. In that case, a mechanical angle connector (for example, an L-shaped mechanical angle connector or an S-shaped mechanical angle connector) is fixed to the frame and fixed to the other side of the shell element next to it.

Then, one installs the window glass as a single glass layer, double glass layer or triple glass layer (or more when so desired). This can be done directly, but usually the window panes rest on a glass block or several glass blocks. In the majority of cases, the glass blocks do not need to be fixed in any special way because they are kept in place by the weight of the window glass.

Glass blocks that may be used for example with respect to the invention have a length of about 6 cm but may also be longer such as about 7 cm, about 8 cm, about 9 cm. The glass blocks may also be smaller and in that case they have a length of, for example, about 3 cm, about 4 cm, about 5 cm. The width obviously depends upon the frame and the glass; however a regularly occurring width is about 30 mm. The width may also be bigger such as, for example, about 35 mm, about 40 mm, about 45 mm, about 50 mm. The thickness of the glass blocks that may be applied preferably ranges between about 1 mm and 6 mm, but every thickness in between may also be applied, such as, for example, about 2 mm, about 3 mm, about 4 mm, about 5 mm.

The window pane is then fixed with a glazing bead, clamps or other means to keep the glass at the appropriate position. These means are, according to the present invention, attached to the frame. This may be done with all kinds of fasteners. The person skilled in the art will take into account a number of factors for the choice of the fasteners. For example, the glazing bead can be attached to the frame by means of screws, but this can also be with glue or nails.

The glazing bead will usually be installed on all sides of the window pane although this is not strictly necessary.

The space between the outside of the window pane and the glazing bead can preferably be closed with sealants, for example a silicone layer. The type of silicone coating will depend on various factors, and the person skilled in the art can make an appropriate choice taking into account the circumstances.

In an interesting embodiment, the frame with the window is placed with a demountable interior finishing. Demountable means being able to take away the interior finishing without structural changes (such as breaking away pieces of wall or plaster or other materials) for example to replace a broken window pane or to install a window pane with better insulation. This also holds in itself a further advantage of the present invention.

In a further embodiment, the frame is installed together with a ventilation channel. Also in this case, this can be done in a way so that the operating part of the ventilation cannot or almost not be noticed from the outside or from the inside of the building.

The frame can actually have any shape. The most common shape of the frame will be rectangular or square, but actually any regular or irregular polygon can be made. Moreover, it is also possible to make round shapes or curved shapes, or combinations thereof.

The material of which the frame is made has to be sufficiently strong to support the window pane and once connected to the shell elements, has to be able to withstand the wind pressure forces on the window pane. The material of the window frame is preferably light. Therefore a lot of different materials are possible, such as wood, metal, synthetic material, bamboo, rubber, cardboard etc. . . . . Other interesting properties of the frame where the material choice plays a role is the insulation.

When making material choices, one can take the recycling possibilities of the materials into account due to the invention. This is another advantage in the use of the frames according to the invention for construction in a durable way.

The frame does not have to consist of one single type of material. It can consist of different materials, with the parts in different materials having the same or a different function.

The material or one of the materials can be wood, where the person skilled in the art will make a choice of wood depending on parameters such as bearing force, size of the frame, insulation value, cost, aspect etc. The wood can also be treated in order to be resistant to water, mold or other factors that can eventually damage the frame.

The material can also be a synthetic material. A possible synthetic material is a type of polyvinylchloride (PVC), a type of polyurethane (PUR), a type of polyisocyanature (PIR) or other synthetic materials. The type of polyurethane can consist of different monomers. The type of polyurethane can be water repellant or water resistant. Other resins can be used as well, such as alkyd resins or epoxy resins.

The synthetic materials have preferably good mechanical properties (such as pressure resistance), good dimensional properties and good (thermal) insulation properties. Another synthetic material is a type of polystyrene, extruded or not. In addition, a lot of these synthetic materials have fire resistant properties.

The material can also be a metal. A suitable metal is for example aluminum, but can also be a type of steel.

The material can also be a type of composite material. A composite material is a material that consists of different components. Usually they are synthetic materials reinforced with fibers. These fibers function as the transmitter of the exerted pulling forces. The matrix wherein the fibers are embedded functions as the transmitter of compression forces and frictional forces. The fibers can be natural fibers (such as flax or hemp), but can also be synthetic (such as fiberglass, aramid, carbon fiber).

One can reinforce the basic material, such as wood, by introducing bars of a stronger material such as metal into the basic material. This can be necessary when windows with very large dimensions are used.

Different types of materials can also be used in the bottom part of the window frame. The bottom part of the window frame is defined as the part that carries the weight of the window pane when the window frame is in a vertical (or quasi vertical) position. Consequently, it is the part that transfers the biggest gravitational forces when the window pane is placed in a vertical position. The bottom part is preferably made of a material that has enough carrying capacity or that transfers the forces in an efficient way to the shell elements with which the window frame is directly or indirectly in contact. The upright sides may consist of the same material as the bottom part but may also consist of other (for example lighter) materials. The upper part may again consist of another material. For irregular shapes, even more combinations of materials may be used.

In the example of a hollow window frame, the window frame may for example be made out of wood. The created space may be left hollow (which means in a usual embodiment that the space is filled with air), but the space can also be filled with extra supporting material. In a preferred embodiment the space can be filled with an insulating material. Examples of insulating materials are a type of polyurethane, a type of polyisocyanate, a type of polystyrene, glass wool, rock wool, etc.

The parts of the frame are kept together with all sorts of fasteners. The person skilled in the art knows what the requirements for these fasteners are. The different parts of the window frame can be kept together by screws, nails or different glues. The person skilled in the art will be capable of choosing a combination of different fasteners.

The size of the frame will be based on the opening for the window. The frame needs to connect with the less regularly shaped shell element. The space between the shell element and the frame can be filled with a layer of insulation material. This is not strictly necessary but is a preferred embodiment.

The way of mounting according to the invention gives the possibility to position the window frame independently of the actual window pane. In some embodiments of the current state of the art, the window pane is already mounted in the window profile. This has the disadvantage that mounting the combination of window profile with window pane is much more difficult because of the total weight of the combination window profile and window pane.

There is no limitation on the number of glass layers such as a single glass layer, double glass layers or triple glass layers. The advantage of the current invention is that there is almost no limitation on the number of glass layers one wishes to apply. In addition, the current invention gives the possibility to change the number of glass layers in a very simple (and thus cost efficient) way or to replace specific glass layers when a specific glass layer does not suffice or when a specific glass layer is broken or cracked.

The mounting of the window pane is relatively simple. In an interesting embodiment the inner dimensions of the frame are a bit bigger than the window pane that will be mounted in the frame. The frame may be bigger in the vertical direction (meaning the vertical direction when the frame is installed in the wall). The frame may also be bigger in the horizontal direction (meaning the horizontal direction when the frame is installed in the wall). In an embodiment the inner dimensions (in the vertical direction or the horizontal direction) of the frame are about minimum 0.01% to maximum 2% bigger than the outer dimensions of the window pane to be mounted. In this way, the window pane may be mounted very easily, but in addition the change of a window pane is much more simple.

In an interesting embodiment the window can extend till the floor. In this case, the interior finishing is open at the bottom, but the floor covering, for example floor tiles, extends till the window. In order to replace the window pane, the inner covering needs to be removed on at least one side (without damaging the inner covering or all other exterior and interior finishing) allowing the window pane to be pulled out at a slight inclination out of the slot that is formed by the combination of the frame and the glass bead.

The current invention allows for minimizing the number of thermal bridges between the inner part and the outer part of the building and therefore allows for optimizing the insulation of the building.

The maintenance of the windows according to this invention is partly facilitated by the complete absence of or the minimizing of moving or rotating parts, such as a hinged window. As insulation requirements of buildings in general and houses in particular continuously increase and thanks to the existence of possibilities to air inner spaces in an efficient way, the use of hinged windows is decreasing. In so-called passive houses, it is ultimately aimed for to make houses quasi air tight.

The demountable interior finishing may come in different forms. The form of the interior finishing is complimentary, so to speak. The demountable interior finishing may be made in such a way that the frame in which the glass is mounted according to the present invention is no longer visible.

In a further embodiment, a ventilation channel can be added to the window frame. A special shape of the frame allows an air flow to pass from the outside to the inside and/or from the inside to the outside. In an embodiment with a ventilation channel, the person skilled in the art can decide to construct the outer wall in such a way that there is sufficient space for the air supply but that the wall still connects to the glass. The air inlet can also be provided on one side or both sides (This explanation assumes a rectangular frame, but as mentioned above, the frame may have whatever form or shape).

The ventilation channel on the inside can be part of the demountable interior finishing. The ventilation channel may have all different forms. The openings through which the air is entering the house or building may have all different shapes, for example circular, oval, rectangular or square. The person skilled in the art will choose the most appropriate shape based on considerations such as structural and aesthetic considerations.

In a further embodiment, the inside of the ventilation channel may be coated with insulation material. (When the whole frame is made of insulation material this is not necessary). In this way, loss of heat is (partly) prevented when the air is passing through the channel. The loss of heat can occur between the inside of the frame (which is in contact for example with the outside air) and the shell elements. With insulation materials the heat loss can be limited to a minimum. The insulation materials that can be used hereto are mentioned elsewhere in this application.

In a particular embodiment a valve is added to the ventilation channel. In this way, the ventilation channel may be closed or opened at the appropriate time. Depending on the requirements of air exchange, the valve may be left totally open or totally closed, but the valve can also be half open or 25% or 75% open.

The valve has preferably such a shape that the ventilation channel is completely closed in a closed position. The ventilation channel may be applied across the complete width or height of the window. In that case the valve has to run across the complete width or height. This structural feature has some consequences for the design of the valve. The valve may have different shapes. For example, the valve may—in a simple embodiment—have the shape of a simple rectangular plate. However, in a special embodiment the valve has a pie-shape.

The valve may be manufactured from all kinds of materials. The person skilled in the art may choose the material based upon the different relevant preconditions. The valve may also be manufactured from a combination of materials. For example, a first plate made from metal (for example aluminum, steel) or a hard polymer (for example polyvinylchloride or polyester) ensures the sturdiness of the valve. A second material may then be applied onto the first plate. Said second material is being applied for example with the purpose to increase the insulation of the system.

The valve may in principle slide in and out, but preferably according to the invention the valve may make a rotational movement.

The first plate is then attached to an axis around which the valve rotates. The axis is applied to the outer edge of the plate. The axis may also be applied to the middle of the plate. The person skilled in the art is able to make a choice based upon the physical requirements.

A pie-shaped valve with the axis placed at a certain distance from the edge is preferred. Moreover in that preferred embodiment there is a recess in the inner lining of the ventilation channel to accommodate part of the pie-shaped valve in the closed position. In this manner the closure is complete and no air can pass. Moreover, this embodiment creates a closure that is insulated, without any thermal bridge.

The frames may be manufactured at another place than the construction site, such as the atelier or workshop of the company that makes the frames. However, the frames may also be made at the construction site. In the latter case, it is still possible to bring prefabricated parts to the construction site and assemble them there.

The advantages of the present invention are plenty.

By the absence of visible profiles it is possible to clean the glass surface very easily, fast and yet efficiently. Moreover the frames of the present invention do not require periodic maintenance such as painting or other treatments, which is necessary with “classic” wooden window profiles.

Another advantage of the present invention is that it is easy to make the construction watertight because of the lack or minimum amount of interfaces or crevices between the different parts.

A further advantage is that one does not need to apply a colour on the frame, as the frame is actually invisible when ready. This entails as such again a reduction in cost because depending upon the technique that is being used to apply the colour, the application of colour by means of paint or lacquer or other means brings potentially a substantial additional cost. Moreover, it is not always easy to choose the “right” color that blends in with the color and the general look of the rest of the building.

There is provided for a maximizing of the glass surface by the lack of a window profile thus in turn maximizing the influx of light. The lack of window profiles has also an additional aesthetic advance, because one has the impression that there is no window. One has the perception to look directly to the outside, as if the inner space is connected in an uninterrupted way with the outside environment.

Yet another further advantage of the present invention is that the present combination of the frame with the window glass is more burglar proof. Indeed, there are no “loose” parts as one finds with a classic window profile.

As mentioned above, the present invention allows constructing buildings in a relatively easy and cost-efficient way that meet the ever stricter regulations concerning energy conservation that are being imposed by the governments of the different countries. The method of the present invention allows maintaining or even lowering the so-called U-values. The U-values of the window (this is nomenclature used by the Belgian government, in other countries there is a different nomenclature for these values) are defined as the amount of heat that is transferred from one side to the other of a surface (such as for example a wall with a window in a building or a construction) per hour and per square meter and per degree temperature difference. The value indicates a degree of insulation of such a surface: a high U-value means a badly insulating surface and a low U-value means a well insulating surface. The unit for the U-value is W/(m²·K).

The present invention allows also for obtaining the right K-level for a building. The K-level of a building is a code indicating the degree of thermal losses through the building shell. The K-level does not only take into account the degree of insulation of the building (which is represented by the U-value, see above) but also takes into account the degree of compactness of a building, indeed a house that is well insulated, but still having large contact surfaces with the outside environment will still lead to big heat losses. The windows according to the present invention maximize the surface area of glass. Indeed no surface area is taken up by window profiles. Consequently, the building can be made more compact while maintaining or even improving the U-values.

Also with respect to sound insulation the frames of the present invention are very useful. In view of the fact that the window frames are not directly exposed to the noise from outside, the frames will not conduct any noise. In an embodiment in which the frame is made out of insulating material, the frames will even work as sound absorbers. Because this embodiment of window frames does not impose a limitation for the thickness of the used glass, triple layer glass or in the future even better thermally insulating or sound insulating glass may be placed.

Also the replacement of a broken glass may be performed more easily, certainly when in combination with a demountable inner finishing. Indeed, there is no need to break the building shell or the inner plastering or inner finishing.

With a changing need for a certain isolation value of the building, which can be imposed or not by the government, given the requirements for a higher K-value for buildings and dwellings, the existing glass may be replaced by new better thermally insulating and/or sound insulating glass.

In view of the potentially light embodiments, this method of installing window frames and windows is faster and safer and with more respect for the worker on the construction site.

Also the preformed inner finishing allows saving time and money during the inner finishing around the windows in comparison with the present state of the art.

The present invention also offers the possibility during the restoration of old buildings. The term “old buildings” is used to refer to old buildings in which glass was not originally applied as a protection against the outside atmosphere. There was basically only a hole in the wall. With the present invention one can give the impression of “hole in the wall”. In such a manner, one can obtain an even higher degree of authenticity in the restoration while still maintaining the possibility to close off the historical building from the outside atmosphere.

### DETAILED DESCRIPTION OF THE FIGURES

The description and discussion of the figures is only for illustration purposes of the embodiments of the invention and are not restrictive.

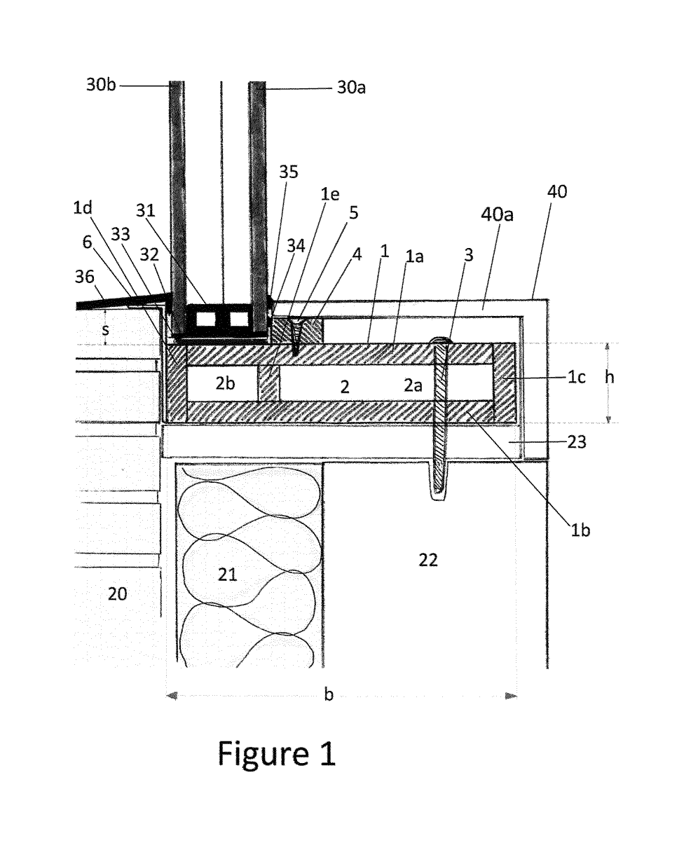

In FIG. 1, a simple embodiment of the present invention is shown in cross-section view. The frame in this embodiment encompasses a rectangular frame of which in this drawing the cross-section of the lower frame part is shown. FIG. 1 illustrates an embodiment in which the cross-section of the frame (1) is rectangular and of which the outside is constituted by the four frame edges (1a, 1b, 1c, 1d) in one material or another. These frame edges are connected to each other by one or another connecting means. In the embodiment shown in FIG. 1 an extra connector (1e) is provided for. This connector provides extra support under the surface of the frame part that has to support the glass (30a and 30b). The frame is placed on a layer of insulation material (23). The surface area of the frame in this embodiment extends over the breath of the wall cavity (21) and is supported by a part of the inner wall (22). It can be seen that the frame ends under the outer wall (20). The depression “s” is defined as the distance (measured vertically, consequently in the condition wherein the frame is mounted) between the average level of the upper side of the frame, upon which the glass (optionally via the glass block) rests and the level of the upper side of the upper stone of the outer wall of the opening in the wall that is provided for the window. The depression “s” may be defined in an analogous way for the sides of the window opening in the outer wall or for the upper side of the window opening in the outer wall. The depression “s” has a certain value that is dependent upon a number of factors. When, for example, the embodiment encompasses a demountable interior finishing and one wants to obtain the effect that the upper side of the upper stone of the lower side of the window opening in the same plane as the demountable interior finishing then the depression “s” has to be equal as the thickness of the upper side (40a) of the demountable interior finishing, moreover also the thickness of the glass bead needs to be “bridged”. As was mentioned already above, a glass block (33) is provided for under the glass. The frame is fastened in this embodiment with a long screw (3), that protrudes through the height (h) of the frame (1) and the insulation layer (23). In this Figure, the wall cavity (21) is filled with insulation material. The window glass or the window glasses (30a, 30b) are fastened with a glass bead (4) that is fastened in this embodiment with a screw (5). A sealant layer (24) is being applied between the window glass (30 a) and the glass bead (4). At the side of the outer wall the frame is fastened by means of a so-called mechanical angle connector (6). This mechanical angle connector can have different shapes. In the embodiment as shown an L-shaped mechanical angle connector is used. The shorter leg of the L-shaped mechanical angle connector rests on the stone of the outer wall and the mechanical angle connector may then—when necessary—be fastened to the stone of the outer wall by one fastening means or another. A mechanical angle connector may also have an S-shape or other shapes. In the embodiment as shown in FIG. 1 a window with double glass layers is shown. Between the two glass surfaces means to keep the glass panes separate (31) (for example made from aluminum) are placed. The whole of window glasses and means to keep the glass panes separate is kept together with a silicon layer that is applied around the combination of the window panes and the means to keep the glass panes separate. The embodiment in FIG. 1 shows an embodiment with demountable interior finishing (40). The demountable interior finishing may be fastened by different means for fastening, even though that is not always strictly necessary. Indeed, it is possible that the demountable interior finishing fits so accurately onto the rest of the construction that fastening the demountable interior finishing with fastening means is actually not necessary. However, when the person skilled in the art opts to fasten then the person skilled in the art is able to select the appropriate fastening method. In view of the demountable nature of the interior finishing one opts preferably for fastening means that are reversible. That means that the fastening means do not cause any damage when these means are removed. Screws and different clicking mechanisms are examples of such reversible fastening means and fastening methods.

The width (b) of the frame is determined by the measurements of the building shell elements in which the frame needs to be placed. Usual measurements for this width range from a minimum of about 20 cm up to a maximum of about 90 cm. All intermediate values such as about 30 cm, about 40 cm, about 50 cm, about 60 cm, about 70 cm, about 80 cm are possible. The most usual widths of the frame are between about 50 cm and about 70 cm.

The height (h) of the frame is dependent upon the building shell elements such as the structural building shell elements with which the person skilled in the art is confronted when placing the frames and the windows in the frames. The usual height ranges between about 3 cm and about 15 cm. However all intermediate values are possible, such as about 4 cm, about 5 cm, about 6 cm, about 7 cm, about 8 cm, about 9 cm, about 10 cm, about 11 cm, about 12 cm, about 13 cm, about 14 cm. Preferably the height is between about 5 cm and about 9 cm.

The ratio between the width and the height in the usual embodiments is between about 22.50 and 1.66. The ratio between width and height in embodiments with a higher preference ranges between 11.66 and 5.55.

The frame can be hollow as shown on the drawing. On the drawing one can see two chambers or cavities (2a, 2b). The invention is not limited to one or two cavities. In the case of the embodiment as is shown in FIG. 1, the two cavities are created by an extra connection (1e) that was placed. Further extra connections may be provided for, thus creating a multitude of chambers. The chambers may be filled with air, however also for example with insulation material. The person skilled in the art can also choose not to use the same cross-section for the complete frame. He can, for example, provide for extra reinforcement connections to support the weight of the window glasses in an efficient and reliable manner. However, the person skilled in the art can also choose to omit extra reinforcement connections in the vertical sides and the upper part.

The width of the used panels (1a, 1b, 1c, 1d, 1e) will depend upon the strength of the material from which the panels are made that are used to constitute the frame. It also depends upon the measurements of the window glass that needs to be framed.

Usual widths range from about 1 mm to about 40 mm. However, all widths in between are possible, such as for example about 2 mm, about 3 mm, about 5 mm, about 10 mm, about 15 mm, about 20 mm, about 25 mm, about 30 mm or about 35 mm.

Finally FIG. 1 shows a sealant edge (35). This sealant edge is not strictly necessary. This can be replaced in principle by a simple sealant layer. The sealant edge (35) protects the upper part of the frame profile and protects partially or completely the upper side of the stone of the outer wall.

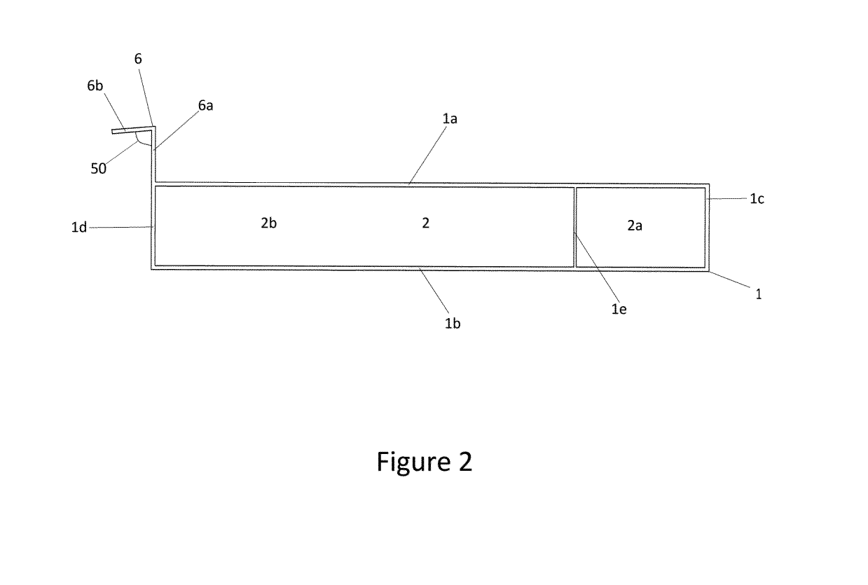

FIG. 2 shows a cross section of a frame part that is made in one piece.

On this Figure, a frame part (1) is shown (that can be used for the lower side, the sides, as well as the upper side of the frame). This frame part is developed thus that it can be manufactured by polymer extrusion. The person skilled in the art understands that the length of the frame part (the dimension that in principle is perpendicular to the plane of the Figure). That length depends solely of the limitations that present themselves by the use of polymer extrusion. The person skilled in the art is able to give the frame part the required length by cutting or sawing it at the appropriate length. The polymer that is used in the extrusion may—as mentioned elsewhere—be polyvinylchloride. In this embodiment the profile (6) is part of the same whole as the frame. This means that it forms a part of the same mold. The frame has three vertical parts (1c, 1d, 1e) that connect the lower side of the frame (1b) with the upper side of the frame (1a). (For clarity, the person skilled in the art will understand that the terms lower, vertical, and upper in this drawing refer to the relative position for the frame part as drawn here.) The lower frame side (1b) may have any width that is necessary given the circumstances. A width may for example be about 350 mm. Dependent upon the glass that the person skilled in the art wants to place, the vertical part may be placed at about 80 mm of the vertical part (1c). The vertical part (1e) is for example placed at that position where extra support is required. By the vertical part (1e) two cavities (2a, 2b) are formed, that may be filled, for example, with air or a certain insulation material such as for example polyurethane (PUR). One may fill one cavity and then leave the other cavity filled with air. The height of the frame part (in other words the length of the vertical part (1c)) is determined by the person skilled in the art in the given circumstances but it may for example range between about 30 mm and about 70 mm, however may also have intermediate values such as for example about 35 mm, about 40 mm, about 45 mm, about 50 mm, about 55 mm, about 60 mm and about 65 mm.

The frame part (6) lies in the extension of the vertical side (1d). Indeed, the vertical part (1d) and the vertical part (6a) of the frame are connected seamlessly. Perpendicular or quasi perpendicular upon the vertical part (6a) of the frame is the part (6b) of the frame. The angle (50) subtended by the part (6a) with regard to part (6b) may be about 90°, however the angle is preferably smaller than 90°. The angle (50) may have a value between about 80° and about 90°, such as for example about 81°, about 82°, about 83°, about 84°, about 85°, about 86°, about 87°, about 88°, or about 89°. The part (6b) rests, after placement in the wall opening, upon the outer wall. Another point of support for the frame is positioned somewhere below the lower frame side (1b). The width of the polymer may be the same all over the frame, however it can also vary depending upon the requirements of the construction with respect to bigger or smaller forces that are exerted on a certain frame part. From a point of view of production cost and weight (which is an important fact for the ease of placing the frame) one wants to keep the thickness of the polymer as small as possible. However, where a bigger strength is required then a bigger thickness of the polymer will be used. The person skilled in the art is able to determine the correct thickness. When bigger scale production is envisaged, the person skilled in the art will determine a standard strength and hence a standard thickness such that the frame part can be used for several different constructions thus lowering the production cost by eliminating the need for resetting the machine. A usual thickness for polyvinylchloride ranges for example between about 1.0 mm and about 5.0 m, such as about 1.5 mm, about 2.0 mm, about 2.5 mm, about 3.0 mm, about 3.5 mm, about 4.5 mm and preferably between about 1.5 mm and about 2.5 mm.

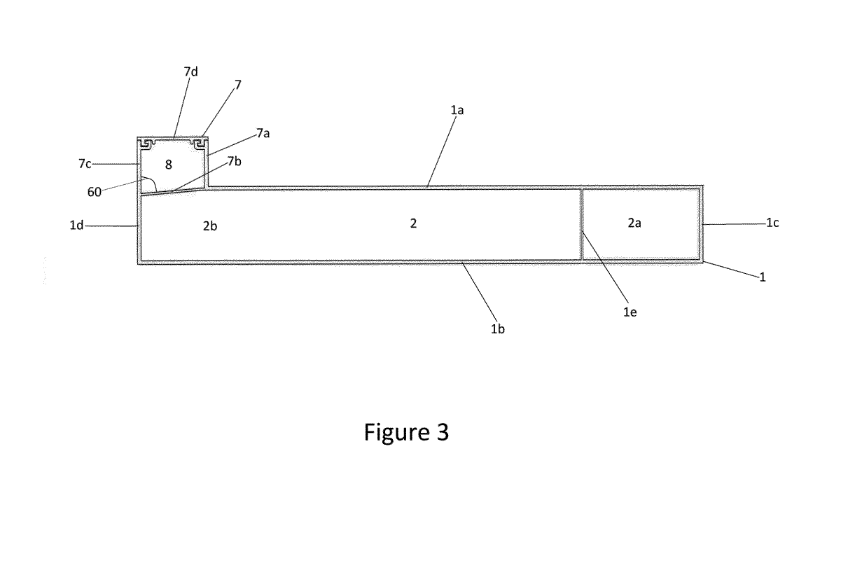

FIG. 3 shows a frame part according to the present invention that can be used when the window extends to (in most cases even extends under) the floor surface. This frame part is designed in such a way that it can be manufactured by polymer extrusion.

The width of the frame part (in this case equal to the length of the lower frame side (1b)) is for example about 400 mm. The vertical parts (1c) and (1e) in this embodiment have the same length, for example about 55 mm. The vertical part (1e) is located at a distance of about 80 mm of the vertical frame side (1c). In this embodiment there is provided for an extra volume defined by the parts (7a), (7b), (7c) and (7d). The part (7a) is about perpendicular to the bottom surface (1a). The length of the part (7a) may range dependent upon the circumstances, and may for example have a length of about 30 mm. The length of the part (7b) is somewhat bigger than the length of the part (7a) thus causing the part (7b) is not in line with the upper surface (1a). The angle (60) is thus smaller than about 90°. This angle is selected as a function of the forces that have to be supported by the frame and on the other hand also the limitation of the manufacturing method for the frame part, such as for example extrusion. The sum of the lengths of part (7c) and part (1d) is for example about 90 mm. The part (7d) is shown here as a part that can be fastened by a click mechanism. The volume that is constituted by parts (7a), (7b), (7c) and (7d) can be used for a diversity of uses. One may fill that space again with an insulation material, however, the volume can also be used to comprise the cabling of all sorts or tubes of all sorts.

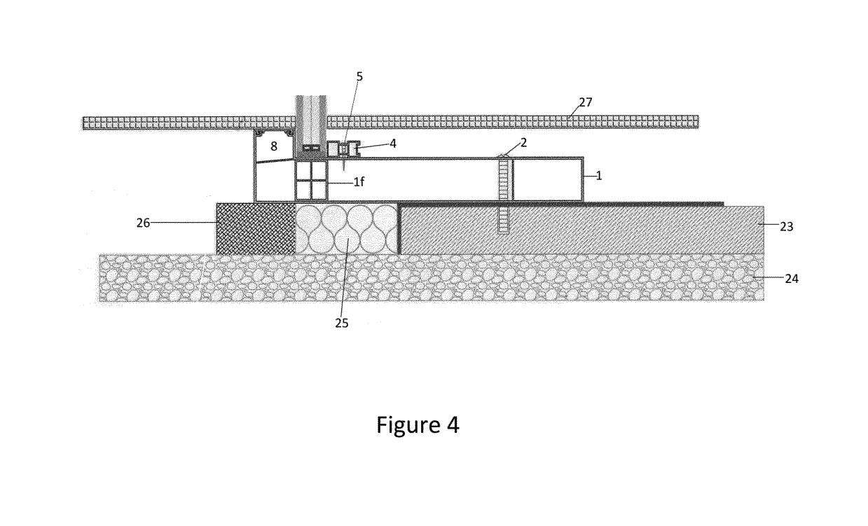

FIG. 4 shows how a variant of the embodiment as shown in FIG. 3 can be applied. Upon the hardened (part of the building shell construction) (24) 3 volumes are created, i.e. volume (23), volume (25), volume (26). The volumes (23) and (26) are lined with fairly hard materials that have load carrying capacity. In between there is the volume (25) that consists of insulation material. In this manner the risk of the existence of a thermal bridge can be lowered. The frame is placed in such a way that part of the frame rests on volume (23) and another part rests upon volume (26). Moreover, the frame is fastened by a means of fastening (2) at the volume (23). The fastening means can be chosen by the person skilled in the art in function of the circumstances, it can be a screw or a bolt. In this embodiment an extra strengthening part (1f) is provided for in the frame. As can be seen from the Figure, this extra strengthening part supports that part of the upper frame side whereupon the glass is placed. The glass is kept at its position by a glass bead (4), which is fastened to the frame with the fastening means (5). This fastening means may be chosen in function of the circumstances, it can be for example a screw. This whole construction is positioned under the floor (27).

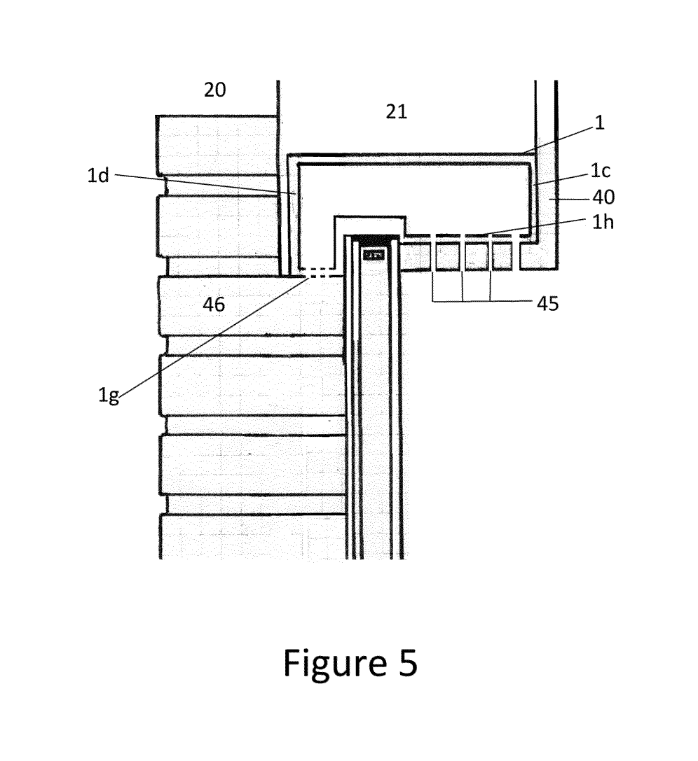

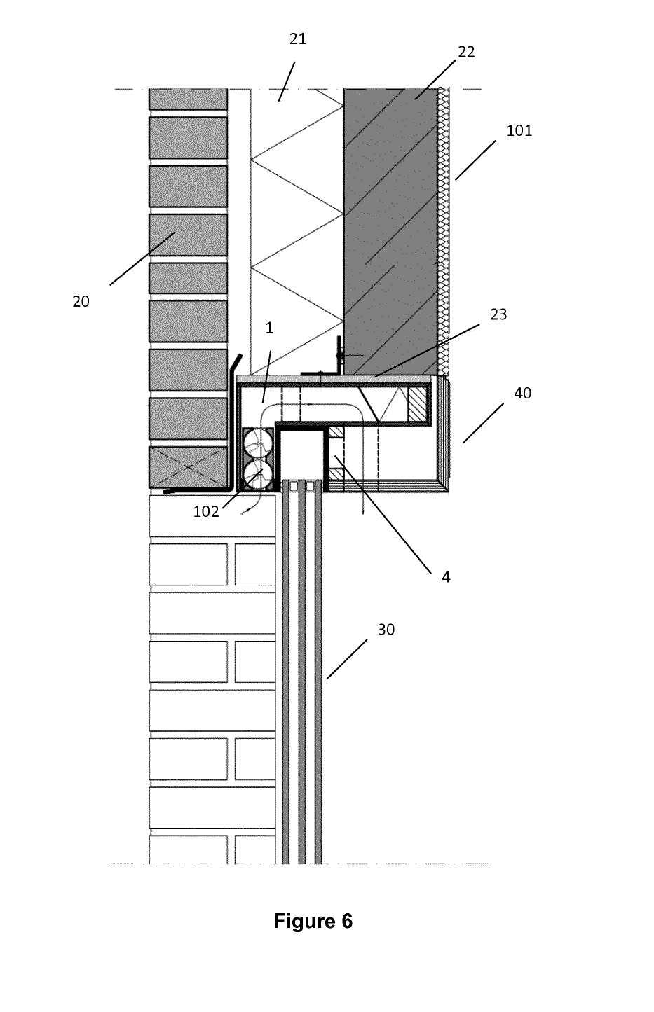

FIGS. 5 and 6 shows a simple example of an embodiment wherein the frame comprises a ventilation channel (102). In this embodiment, the cavity lined by the frame sides is used as a connection between the inner air and the outer air. The shape of the cross section is as shown in FIG. 5 or 6 (even though the drawings are only illustrative examples). The shape of the frame part is an angular C, wherein the one leg (1d) of the C is longer than the other leg (1c) of the C, and whereby the cavity of the C can be used to hold the glass (30). To allow the air to pass, openings (46) are provided for in the frame side (1g) at the outside of the building and there are openings (45) provided for in the frame side (1h) at the inner side of the building. The openings are provided for in a certain distribution pattern in the respective frame sides.

Moreover in such an embodiment the inner side of the frame may be insulated, for example by providing an insulating layer as inner lining and/or outer lining (23). In this way one can limit the possibility of the air channel forming a thermal bridge.

In yet another embodiment it may be possible to provide for a valve (se circular elements shown in FIG. 6) thus creating in closed position a complete thermal barrier between the outer side and the inner side of the building.

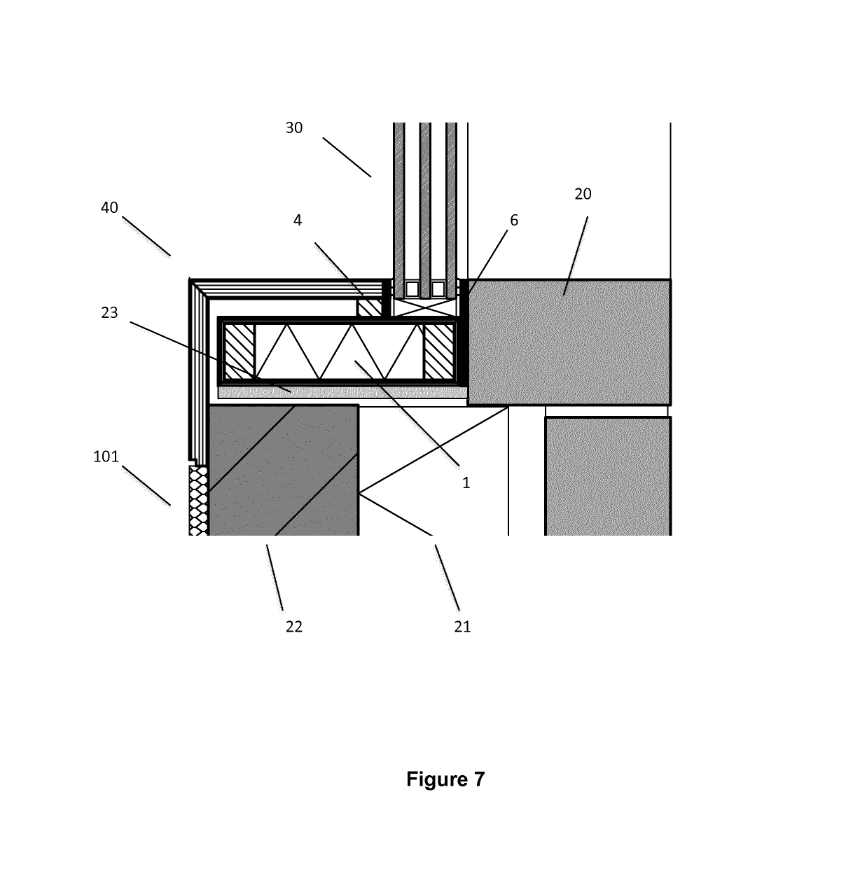

FIG. 7 shows an cross section of a jamb with a raised edge up to the outer edge generated by the outer shell (20) of the building shell elements. Again, the beam shaped profile (1) bridges the entire width of the inner building shell elements, i.e. the inner wall (22) and the wall cavity (21). The glass pane (30) is placed against the raised edge (6), and kept in position by the glass beads (4). The inner cover (40) is installed over the beads and equal to the finishing layer (101) of the inner wall. Again, an underlying insulation member (23) assures absence of thermal bridges.

1. A window frame comprising beam shaped profiles, characterized in that the width of said beam shaped profiles cover the entire width of an inner wall; characterized in that the height of said beam shaped profiles is less than the height of an edge generated by outer building elements; characterized in that the window frame further comprises an demountable interior finishing; and further characterized in that the beam shaped profiles comprise a raised edge or chamber at a side facing an exterior.

2. The window frame according to 1, wherein the height of said raised edge or chamber equals up to the height of the edge generated by the outer building elements.

3. The window frame according to claim 1, wherein the beam shaped profiles are hollow.

4. The window frame according to claim 3, wherein the hollow beam shaped profiles comprise one or more dividing members separating the hollow beam shaped profiles in two or more chambers.

5. The window frame according to claim 1, further comprising glass retainment elements.

6. The window frame according to claim 5, wherein the demountable interior finishing is mounted over said glass retainment elements.

7. The window frame according to claim 1, wherein the demountable interior finishing bridges the height between an upper surface of the beam shaped profiles and the height of the edge generated by the outer building elements.

8. The window frame according to claim 1, wherein a ventilation channel is incorporated in one or more of the beam shaped profiles.

9. The window frame according to claim 4, wherein one or more of the dividing members are removable.

10. The window frame according to claim 1, wherein the raised chamber comprises a removable lid.

11. The window frame according to claim 4, wherein one or more of the chambers within the hollow beam shaped profiles are filled with an insulating material.

12. The window frame according to claim 6, wherein dividing members are present at the side of the beam shaped profiles comprising the raised edge or chamber, over a distance of at least the thickness of the window pane that will be mounted in the frame.

13. The window frame according to claim 1, wherein the material of the beam shaped profiles is chosen from a group consisting of wood, aluminium, composite material or polymer.
